(19) United States
(12) Patent Application Publication
(10) Pub. No.: US 2014/0154375 A1
(43) Pub. Date: Jun. 5, 2014

(54) METHODS FOR REHYDRATING TRIPE

(71) Applicant: BIRKO CORPORATION, Henderson, CO (US)

(72) Inventors: Terry McANINCH, Westminster, CO (US); Elis M. OWENS, Littleton, CO (US); Wayne LARSON, Fort Collins, CO (US)

(73) Assignee: BIRKO CORPORATION, Henderson, CO (US)

(21) Appl. No.: 14/092,348

(22) Filed: Nov. 27, 2013

Related U.S. Application Data
(60) Provisional application No. 61/732,130, filed on Nov. 30, 2012.

(51) Int. Cl. A23L 1/277; A23L 1/312

(52) U.S. Cl. CPC A23L 1/277; A23L 1/312
USPC 426/253

(57) ABSTRACT

A method for processing tripe includes refining tripe with at least one bleaching agent and at least one alkaline material to improve tripe appearance, and contacting the treated tripe with an alkaline builder at a temperature of about 110° F. to 160° F. Tripe may be rinsed with cold water before packaging. The methods of processing tripe may provide tripe with enhanced appearance appealing to consumers, while increasing margin profits to meat packing plants due to higher tripe yield and lower operation cost.

### PRIORITY CLAIM

This application claims the benefit of the filing date of U.S. Provisional Patent Application Ser. No. 61/732,130, filed Nov. 30, 2012, for “METHODS FOR REHYDRATING TRIPE.”

### FIELD OF THE DISCLOSURE

Embodiments of the present disclosure relate to methods for rehydrating tripe.

### BACKGROUND OF THE DISCLOSURE

The profitability of a meat packing plant depends largely on the ability of the plant to process all parts of the animal carcass into saleable products. This includes the economical processing of edible tissues, such as tripe, into consumable products.

Tripe is a type of edible offal from the stomachs of various domesticated farm animals, most commonly cattle stomachs. Beef tripe is usually only made from the first three chambers of cattle stomach: the rumen or “paunch” (blanket or smooth tripe), the reticulum (honeycomb tripe and pocket tripe), and the omasum (book or bible tripe). The tripe from the abomasum chamber of cattle stomach (reed tripe) is consumed to a much lesser extent due to its glandular tissue content.

Tripe can be consumed by humans and is considered by some to be a delicacy. However, tripe must be adequately processed prior to human consumption. Tripe processed for human consumption is commonly referred to as scalded tripe.

Commercial meat packing plants prepare tripe by cutting out the stomach of the slaughtered animal and removing the paunch contents. Tripe is washed with water to cleanse out residual contents and other impurities. The washed tripe is transferred to a refiner where a mixture of water and chemicals is used to further cleanse the tripe, neutralize the tripe pH, remove fat and mucous membranes, and optionally bleach the tripe. Before being packaged for sale, tripe is thoroughly rinsed with water to remove chemicals, wherein the rinsed water usually starts out hot and finishes with cold tap water.

The natural appearance of tripe depends largely on the eating habits of the cattle. Typically tripe appears stained or darkened even after the washing and refining processes. As light appearing tripe is strongly preferred by consumers, several methods have been reported to improve the tripe appearance.

Canadian Patent Publication 516823 discloses a method of bleaching tripe involving treating tripe in a dilute solution of hydrogen peroxide and a small percentage of acidic agent, preferably acetic acid, at a temperature of 70° F. to 75° F. for about 24 hours, and placing the treated tripe in a container filled with running water for another 24 hours with occasional stirring to ensure the complete removal of the peroxide.

U.S. Pat. No. 6,348,226 discloses a method of bleaching tripe using a liquid bleaching agent composed of hydrogen peroxide and peracid precursor selected from the group consisting of tartaric acid, malic acid, maleic acid, and acetic acid.

U.S. Pat. No. 7,470,444 discloses a method of bleaching tripe using hydrogen peroxide, surfactants and organic acids selected from the group consisting of citric acid, lactic acid, tartaric acid, malic acid, maleic acid, acetic acid, glycolic acid, oxalic acid, fumaric acid, and succinic acid.

### SUMMARY OF THE DISCLOSURE

A particular embodiment is drawn to a method for processing tripe that includes: contacting the tripe with at least one bleaching agent and at least one alkaline material for a period of time sufficient to bleach the tripe; contacting the tripe with a solution comprising an alkaline builder at a temperature of at least about 110° F.; and contacting the tripe with cold water having a temperature below about 40° F.

In these and other embodiments described in the present disclosure, tripe processing can be conducted in a normal tripe washing operation using standard or slightly modified equipment in an online process.

In some embodiments, a method for processing tripe includes: contacting tripe with at least one bleaching agent and at least one alkaline material to improve tripe appearance; contacting the treated tripe with a solution comprising an alkaline builder at a temperature of about 110° F. to 160° F. to raise a surface pH of the tripe from about 12.2 to about 12.8; and contacting the tripe with cold water having a temperature below about 40° F.

In other embodiments, a method for processing tripe includes washing tripe with water at a temperature of at least 110° F., refining tripe with at least one bleaching agent and at least one alkaline material, and contacting the treated tripe with a solution comprising an alkaline builder at a temperature of about 110° F. to 160° F. to raise a surface pH of the tripe to about 12.5, and contacting the tripe with cold water having a temperature below about 40° F.

In yet another embodiment, a method for processing tripe includes a washing process for washing tripe with water, a refining process that includes at least one bleaching agent and at least one alkaline material, followed by rinsing the tripe with hot water (e.g., 125° F.) for about at least 30 seconds, contacting the tripe with hot water and about 20 ounces of a caustic-based alkaline cleaner for about at least 1 minute and 15 seconds, rinsing the tripe with cold water (e.g., less than about 40° F.) for about at least 2 minutes, and spinning the tripe for about at least 20 seconds. The pH of the surface of the tripe is less than 10.

### DETAILED DESCRIPTION OF THE DISCLOSURE

The present disclosures now will be described more fully hereinafter, but not all embodiments of the disclosure are shown. While the disclosure has been described with reference to certain embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof.

Particular embodiments of the method for processing tripe may include: contacting tripe with at least one bleaching agent and at least one alkaline material to improve tripe appearance and hydration; contacting the treated tripe with a solution comprising an alkaline builder at a temperature of about 110° F. to 160° F. to raise a surface pH of the tripe to about 12.5; and contacting the tripe with cold water having a temperature below about 40° F.

In another embodiment, a method for processing tripe may include washing tripe with water at a temperature of at least 140° F., refining tripe with at least one bleaching agent and at least one alkaline material, contacting tripe with a solution comprising an alkaline builder at a temperature of about 110° F. to 160° F. to raise the surface pH of tripe to about 12.5, and contacting tripe with cold water before packaging. In some embodiments, the surface pH of the trip is maintained at 12.5 for about 1 to about 2 minutes.

In a particular embodiment, the cold water rinse includes rinsing the tripe after the washing and refining processes with cold water that is colder than the tap water available in most processing plants. Temperatures below about 40° F. are suitable for use as a cold water rinse. By way of nonlimiting example, the cold water rinse temperature may be about 32° F. to about 35° F. In certain embodiments, the tripe can be rinsed with cold water for a suitable amount of time to reduce the temperature of the tripe to less than about 70° F., and in other embodiments to about 60° F. For example, tripe may be subjected to a cold water rinse for 1:30 minutes to 3 minutes. It is understood that the temperature of the cold water rinse and the duration of the rinse cycle can be modified depending on various variables existing in the operation, such as the amount of tripe being treated, the type of machinery being employed, and the size of the equipment. After rinsing, and depending on the factors existing in the processing operation, the tripe is expected to have a pH below about 10.

### Washing Process

The washing process is performed to remove any soil left on tripe after its contents have been emptied and may be performed in a washer apparatus. Tripe may be washed with water at a temperature of at least 120° F. to effectively stop the on-going activity of digestive acids in the rumen stomach. When desired, the washing process time may be no more than 10 minutes. For example, in some embodiments, tripe may be washed with water at a temperature of about 130° F. to 170° F. for about 3 to 6 minutes. In other embodiments, tripe may be washed with water at a temperature of about 143° F. to 150° F. for about 4 minutes. In yet other embodiments, tripe may be washed with water at a temperature of about 148° F. for 4 minutes, or with water at a temperature of about 151° F. for about 3 minutes and 30 seconds. It is understood that the type of washing equipment employed, size of the equipment, and amount of tripe being treated can affect the temperature of the wash water and the duration of the wash cycle. As such, persons of skill in the art can modify the aforementioned parameters to suitably wash the tripe tissue.

### Refining Process

After the washing process, tripe is subjected to a refining process where it is bleached. The refining process may be performed in an apparatus called a refiner. When appropriate, tripe may be treated in a single tripe processing apparatus functioning as both washer and refiner.

In refining process, tripe may be contacted with at least one bleaching agent and one alkaline material for a period of time sufficient to bleach the tripe to desired whiteness. In some embodiments, tripe may be contacted with bleaching agent(s) and alkaline material(s) at a temperature of about 120° F. to145° F. for about 2 to 7 minutes. For example, in some embodiments, tripe may be contacted with bleaching agent(s) and alkaline material(s) at a temperature of about 130° F. to138° F. for about 4 minutes. In other embodiments, tripe may be contacted with hydrogen peroxide and at least one alkaline material at a temperature of about 130° F. to135° F. for about 4 minutes. It is understood that the type of refining equipment employed, size of the equipment, and amount of tripe being treated can affect the temperature of the water and the duration of the refining cycle. As such, persons of skill in the art can modify the aforementioned parameters to suitably refine the tripe tissue.

When more than one alkaline material is used, they may be pre-mixed and then added to a refiner for tripe refining. Alternatively, the alkaline material agents may be added separately and individually to tripe in the refiner. In some embodiments, the alkaline material may be added to tripe first, followed by the bleaching agent.

In some embodiments, the alkaline material may be added first to tripe in the refiner and allowed to contact with tripe for about 1 minute before the bleaching agent may be added. Then, tripe may be allowed to contact with both the bleaching agent and alkaline material for about 4 to 5 minutes.

The dosage of bleaching agent may vary depending on several factors including, but are not limited to, the concentration of the bleaching agent and the degree of tripe whiteness desired. In some embodiments, the bleaching agent used during refining process may be about 0.1% to about 0.5% on an active available oxygen basis relative to the weight of tripe. In other embodiments, the bleaching agent used during refining process may be about 0.2% to about 0.3% on an active available oxygen basis relative to the weight of tripe.

Various non-toxic bleaching agents may be used, provided they do not damage tripe or impart any objectable taste or color to tripe. Any United States Department of Agriculture Food Safety Inspection Service (FSIS) approved bleaching agent may be used. Examples of the bleaching agents may include, but are not limited to, hydrogen peroxide, persulfate, or the like.

The amount of the alkaline material used for the refining process may be about 0.05% to about 0.2% alkaline material reported as equivalent to Na₂O active basis relative to the weight of tripe.

Any alkaline materials may be used, provided they do not damage tripe. Non-limiting examples of the alkaline materials may include sodium hydroxide (caustic soda), potassium hydroxide (caustic potash), calcium hydroxide (lime), magnesium hydroxide (magnesia), trisodium phosphate, sodium metasilicate, any FSIS-approved alkaline materials for washing tripe, or combinations thereof.

The term “food grade” is recognized in the art as designating materials suitable for human use. In the United States, the Food and Drug Administration (FDA) may define such standards by regulatory action that may take the form of regulations or guidelines. This may be supplemented by conventional industry practices where the standards for food grade materials are well known in the art. A number of countries have analogous agencies to the FDA, such as the European Food Safety Authority, that define the food grade quality standards for their particular jurisdictions. Such standards are generally compatible with those in the United States.

After the refining process, tripe may be washed with water to remove residual chemicals (e.g., soaps, surfactants) before further tripe processing.

### Alkaline Rehydration Process

After the refining process, tripe is subjected to an alkaline wash process by washing with a solution comprising an alkaline builder to raise the surface pH of tripe to from about 12.2 to about 12.8 at a temperature of about 110° F. to 160° F. In one particular embodiment, the alkaline wash process may be performed at a temperature of about 130° F. to 135° F. for about 1 to 2 minutes.

The alkaline builder may include any alkaline compound including, but not limited to, sodium hydroxide (caustic soda), potassium hydroxide (caustic potash), calcium hydroxide (lime), magnesium hydroxide (magnesia), trisodium phosphate, sodium metasilicate, or combinations thereof.

### Post-Rehydration Rinse

After the alkaline rehydration wash process tripe may be chilled by rinsing with cold water, may be about 1 to 2 minutes, and then packaged without dry spin cycle.

In some embodiments, the chill process may be performed as rapidly as possible, and tripe may be packaged and frozen before warming up to prevent the seeping out of water after the chill process.

In some embodiments, the cold water used for the chill process may have a temperature of about 32° F. to 35° F. Other embodiments may use cold water having a temperature of less than about 40° F.

The methods of processing tripe may be applied to tripe derived from any chamber of the cattle stomach. In some embodiments, the methods may be used for processing scalded tripe and honeycomb tripe.

The disclosed methods of processing tripe may not only minimize the shrinkage of tripe during processing, but may also rehydrate tripe and thereby increase tripe yield. Therefore, the disclosed method of processing tripe may offer an enhanced tripe yield and, consequently, an increased profit margin to meat packing plants.

In some embodiments, the methods of processing tripe may increase the tripe yield (i.e., tripe weight) by at least 25%. In other embodiments, the disclosed method may increase the tripe yield by at least 35%. In particular embodiments, the disclosed method may increase the tripe yield by about 45%.

In certain embodiments, methods of processing tripe may allow the meat packing plants to increase the tripe profit margins by at least about 30% and to supply the markets with tripe with improved appearance appealing to consumers, such as whiteness and texture.

In certain embodiments, a method for processing tripe may include a washing process for washing tripe with water, a refining process comprising treating tripe with at least one bleaching agent and at least one alkaline material, an alkaline rehydration process comprising contacting tripe with a solution comprising an alkaline builder to raise the surface pH of tripe to about 12.5, and final refining rinse process where tripe is rinsed with cold water before packaging.

As previously noted, the process used in most plants today involve cutting open the stomach, emptying out its contents, a quick cold water rinse to remove gross soil that did not empty out, a hot water wash which essentially removes any remaining paunch material, an alkaline wash/bleach cycle that finishes the cleaning process and beaches it, followed by a thorough rinse which usually starts out hot and finishes with cold tap water.

A particular embodiment of the tripe boosting process of the present disclosure commences immediately following the above mentioned rinses. A short alkaline wash step can raise the surface pH of the tripe to about 12.5 for 1 to 5 minutes to cause the tripe tissue to swell and absorb water. This is followed by a cold water rinse step—colder than the tap water temperature available in most plants (e.g., 32 to 35° F.). This rapid chill step closes the porosity of the protein tissue and retains the water that caused the swelling to take place. The tripe is rapidly chilled and then packaged into a blast freezer before it has a chance to warm up and purge water after the chilling process.

In alternative embodiments, the disclosed method may further include the addition of a bleaching agent during the short alkaline rehydration step to further bleach the tripe.

In another embodiment, three loads were run using 20 ounces of a caustic-based alkaline cleaner per load for 90 seconds at 125° F. immediately following the regular tripe washing step in their normal schedule. A suitable alkaline-based cleaner that was used with the present process includes Swell™ (available from Birko Corporation, Henderson, Colo.). This wash was then rinsed with 33° F. water for 2 minutes with a flow of 120 gallons per minute. Total product boxed from those 3 loads was 20 boxes tripe @ 60 pounds per box and 31 boxes of honeycomb @10 pounds per box. That represents a total of 1510 pounds of tripe and honeycomb produced or an average of 503 pounds per load. Their normal production averages about 370 pounds per load. This represents a 36% gain in yield per load compared to normal tripe washing processes. There was minimal purge observed.

In yet another embodiment, four consecutive loads were ran using 20 ounces of Swell per load for 90 seconds at 125° F. The difference with the previous embodiment is that the normal tripe wash step immediately preceding this step is reduced by 30 seconds in order to reduce any possible over cooking. After the 2 minute cold water rinse, the product was boxed and sent to a rapid blast freezer. Total product boxed was 29 boxes @ 60 pounds and 37 boxes @10 pounds per box. That is 2110 pounds of tripe produced or 527 pounds per load. That represents a yield of 42.5% increase over normal process production. Minimal purge was observed the following morning after freezing.

In other embodiments, the disclosed method of processing tripe may be automated. Several processing factors may be controlled during automatic process to achieve tripe with desired appearances and yield. Non-limiting examples of such factors may include, but are not limited to, processing time, processing temperature, load volume, chemical concentration in relation to material load and water volume.

Accordingly, the disclosed methods of processing tripe may provide rehydrated tripe having an enhanced appearance appealing to consumers, while increasing margin profits to meat packing plants due to higher tripe yield and lower operation cost.

The disclosed methods of processing tripe may be applied to stomach of various ruminant animals including, but not limited to, cattle, sheep, and goats.

Furthermore, it is understood that the disclosed methods of processing tripe may be applied to other animal tissues similar to tripe. Non-limiting examples of animal tissues may include, but are not limited to, animal intestines (casings), or tendons.

The disclosed methods can be performed within the context of normal tripe online washing/refining operations, without overloading the tripe washing/refining machines, and can be applied without reducing the speed of the online process. The disclosed methods further eliminate the need to transport the washed/refined tripe to a separate, offline facility that can take up to 24 hours to achieve rehydration of tripe.

While the disclosure has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

1. A method for processing tripe, comprising:
contacting the tripe with at least one bleaching agent and at least one alkaline material for a period of time sufficient to bleach the tripe;
contacting the tripe with an alkaline builder at a temperature of at least about 110° F.; and
contacting the tripe with cold water having a temperature below about 40° F.

2. The method of claim 1, wherein contacting the tripe with an alkaline builder at a temperature of at least about 110° F. comprises contacting the tripe with an alkaline builder at a temperature of from about 110° F. to about 160° F.

3. The method of claim 1, wherein contacting the tripe with an alkaline builder comprises contacting the tripe for a sufficient period of time to raise the surface pH of the tripe to from about 12.2 to about 12.8.

4. The method of claim 1, comprising:
contacting the tripe with at least one bleaching agent and at least one alkaline material at a temperature of about 120° F. to about 145° F. for a period of time sufficient to bleach the tripe to desired tripe whiteness; and
contacting the tripe with an alkaline builder for a sufficient period of time to raise a surface pH of the tripe to about at least 12.5.

5. The method of claim 1, wherein the bleaching agent is present in an amount from about 0.1% to about 0.5% on an active available oxygen basis based on tripe weight.

6. The method of claim 1, wherein the bleaching agent is present in an amount from about 0.2% to about 0.3% on an active available oxygen basis based on tripe weight.

7. The method of claim 1, wherein the alkaline material is in an amount from about 0.05% to about 0.2% alkaline material reported as equivalent to Na₂O active basis based on tripe weight.

8. The method of claim 1, wherein the alkaline material includes a member selected from the group consisting of sodium hydroxide, potassium hydroxide, calcium hydroxide, magnesium hydroxide, trisodium phosphate, sodium metasilicate, and combinations thereof.

9. The method of claim 1, wherein the alkaline builder includes a member selected from the group consisting of sodium hydroxide, potassium hydroxide, calcium hydroxide, magnesium hydroxide, trisodium phosphate, sodium metasilicate, and combinations thereof.

10. The method of claim 1, wherein contacting the tripe with an alkaline builder further comprises contacting the tripe with a bleaching agent.

11. The method of claim 1, where the cold water has a temperature of about 32° F. to 35° F.

12. The method of claim 1, wherein contacting the tripe with the cold water comprises contacting the tripe with cold water for about 1 to about 2 minutes.

13. The method of claim 1, wherein the tripe includes at least one of scalded tripe and honeycomb tripe.

14. The method of claim 1, comprising contacting the tripe with an alkaline builder is performed for a duration of from about 2 minutes to about 7 minutes.

15. The method of claim 1, characterized by an automatic process.

16. A method for processing tripe, comprising:
washing the tripe with water at a temperature of at least 120° F.;
treating the tripe with at least one bleaching agent and at least one alkaline material to bleach the tripe to desired tripe whiteness;
contacting the tripe with an alkaline builder to raise a surface pH of the tripe to about 12.5; and
contacting the tripe with cold water before packaging.

17. The method of claim 16, where the cold water has a temperature below about 40° F.

18. The method of claim 16, where the cold water has a temperature of from about 32° F. to 35° F.

19. The method of claim 16, wherein contacting the tripe with the cold water comprises contacting the tripe with cold water for about 1 to about 2 minutes.

20. The method of claim 16, wherein contacting the tripe with an alkaline builder further comprises contacting the tripe with a bleaching agent.

21. The method of claim 16, wherein the tripe is contacted with an alkaline builder for about 1 to about 5 minutes.

22. The method of claim 16, wherein contacting the tripe with the cold water comprises contacting the tripe with cold water until the temperature of the tripe is less than 65° F.
